(19) United States
(12) Patent Application Publication
(10) Pub. No.: US 2013/0017923 A1
(43) Pub. Date: Jan. 17, 2013

(54) PLANETARY GEAR DEVICE

(71) Applicants: Jongsool Park, Guynggi-Do (KR); Jinyoung Hwang, Gyunggi-do (KR); Hyukjun Lee, Gyunggi-Do (KR)

(72) Inventors: Jongsool Park, Guynggi-Do (KR); Jinyoung Hwang, Gyunggi-do (KR); Hyukjun Lee, Gyunggi-Do (KR)

(73) Assignee: Hyundai Motor Company, Seoul (KR)

(21) Appl. No.: 13/184,181

(22) Filed: Jul. 15, 2011

(51) Int. Cl. F16H 57/08

(52) U.S. Cl. 475/331

(57) ABSTRACT

Provided is a planetary gear device, in which a plurality of double pinion gears arranged between a sun gear and a ring gear may include a first pinion gear and a second pinion gear, first pinion gear is in contact with sun gear and second pinion gear at three points while second pinion gear is also in contact with ring gear and first pinion gear at three points.

### BACKGROUND OF THE INVENTION

1. Field of the Invention

The present invention relates to a planetary gear device, and more particularly, to a planetary gear device having excellent durability and high efficiency by reducing the load applied to a pinion shaft in a double pinion type.

2. Description of Related Art

In general, environmental friendly vehicles recently require multi-stages of an automatic transmission to satisfy the regulations about environment and fuel efficiency, and the change becomes gradually fast.

It is required to completely provide a desired gear ratio while using a limited number of planetary gears and friction members, because the number of stages increases but the inter-stage ratio decreases in the multi-stage required for the automatic transmission. However, it is necessarily difficult to substantially achieve it for technical and other various reasons.

The planetary gear device includes a sun gear, a ring gear, a pinion gear, and a planetary carrier.

In general, in a single pinion planetary gear, the lever ratio (a/b) is expressed by Zr (the number of teeth of a ring gear)/Zs (the number of teeth of a sun gear)=a/b, in which the configuration cannot be implemented when the lever ratio (a/b) is close to 1.

On the other hand, in a double pinion planetary gear, the lever ratio (a/b) is expressed by Zr (the number of teeth of a ring gear)/Zs (the number of teeth of a sun gear)−1=a/b, in which the configuration can be implemented because of Zr/Zs=2 even if the lever ratio (a/b) is close to 1.

Since the performance of the planetary gear device can be increased, when the lever ratio (a/b) is close to 1, a planetary gear device of which the lever ratio (a/b) is close to 1 is necessarily required for an automatic transmission with high multi-stages.

Therefore, since it is impossible to implement a lever ratio (a/b) close to 1 with the single pinion type of planetary gear, the double pinion type of planetary gear device is applied to an automatic transmission with high multi-stages.

However, the double pinion type of planetary gear device has a structural problem that excessive load is applied to the pinion shaft.

FIG. 1 shows a double pinion type of planetary gear device according to the related art, in which a structure where excessive load is applied to a pinion shaft is shown.

As shown in the figure, the planetary gear device includes a plurality of double pinion gears 12 each having a first pinion gear 13 and a second pinion gear 14 that are made in pairs by pinion shafts 13a and 14a equipped with planetary carriers between a sun gear 10 and a ring gear 11.

First pinion gear 13 is in contact with sun gear 10, second pinion gear 14 is in contact with ring gear 11 and with first pinion gear 13 in only one direction, in which second pinion gear 14 is spaced apart at a distance A from first pinion gear 13.

However, in this structure, force F1 is applied to the contact surface between first pinion gear 13 and second pinion gear 14 and radial force exists, such that large resultant force is applied to pinion shafts 13a and 14a, such that the efficiency durability are necessarily low.

FIG. 2 shows another example of a double pinion type of planetary gear device according to the related art.

As shown in the figure, the planetary gear device includes a plurality of double pinion gears 22 each having a first pinion gears 23 and a second pinion gears 24 that make a pair between a sun gear 20 and a ring gear 21.

First pinion gear 23 is in contact with sun gear 20 and second pinion gear 24 is in contact with first pinion gear 13 in both directions, in contact with ring gear 21.

In the type, in a double pinion gear 30 that is one of the double pinion gears, first pinion gear 33 is not in contact with sun gear 20, such that at least one first pinion gear 33 is spaced apart at a distance B from sun gear 20.

However, according to this structure, torque is not transmitted from sun gear 20 to at least one first pinion gear 33, such that force Fl at first pinion gear 23 necessarily increases to transmit the same magnitude of torque [T(Torque)=N(number of gears)*R(radius)*F1(force)].

This result does not correspond to the object that increasing the number in order to reduce the magnitude of the force F1 applied to first pinion gear 23 and the efficiency necessarily decreases.

Further, the radial balance of the total force of the planetary gear device is broken by radial force generated by second pinion gears 34 and 35 by the both-directional contact of first pinion gear 33 that is not in contact with sun gear 20 and the motion of the planetary carrier and ring gear 21 is made not symmetrical, but asymmetrical, such that it necessarily causes vibration.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a planetary gear device for an automatic transmission having high efficiency and improve durability by reducing force applied to a first pinion gear by ½, offsetting radial force, and reducing force applied to a pinion shaft, by arranging a plurality of double pinion gears, in which first pinion gears are in contact with a sun gear, second pinion gears are in contact with a ring gear, and first pinion gears and second pinion gears are in contact, between the sun gear and the ring gear.

In an aspect, the present invention provides a planetary gear device with double pinion gears arranged between a sun gear and a ring gear, in which wherein the double pinion gears each may have a planetary carrier fitted on a pinion shaft that may be a rotary shaft, and may include a first pinion gear and a second pinion gear that may be arranged in contact with each other, and may be respectively contact with the sun gear at one point and with the ring gear at one point.

A plurality of the double pinion gears having the first pinion gear and the second pinion gear, which makes a pair, may be arranged in a plurality of pairs between the sun gear and the ring gear, and the first pinion gear and the second pinion gear may be in contact at three points.

In another aspect of the present invention, the planetary gear device may include a plurality of double pinion gears arranged between a sun gear and a ring gear, wherein each of the double pinion gears may have a first pinion gear having a first pinion shaft wherein the first pinion gear may be engaged with the sun gear, a second pinion gear having a second pinion shaft wherein the second pinion gear may be engaged with the ring gear and the first pinion gear, and a planetary carrier fitted on the first and second pinion shafts, wherein each double pinion gear may be disposed between the sun gear and the ring gear in series and a second pinion gear of a double pinion gear may be engaged with a first pinion gear of an adjacent double pinion gear such that a first pinion gear of each double pinion gear may be in contact with the sun gear and adjacent second pinion gears at three points and the sun gear and a second pinion gear of each double pinion gear may be in contact with adjacent first pinion gears and the ring gear at three points.

According to the exemplary embodiments of the present invention, since a plurality of double pinion gears arranged between a sun gear and a ring gear is in contact with each other in both directions, it is possible to reduce force exerted between the pinion gears by ½ and offset radial force.

Therefore, it is possible to reduce force applied to the pinion shaft, such that it is possible to considerably increase efficiency and durability.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIGS. 1 and 2 are views showing the configuration of a double pinion type of planetary gear device of the related art.

FIG. 3 is a view showing the configuration of a double pinion type of planetary gear device according to an exemplary embodiment of the present invention.

FIGS. 4 and 5 are views comparing the operations of the double pinion type of planetary gear devices according to the related art and the exemplary embodiment of the present invention.

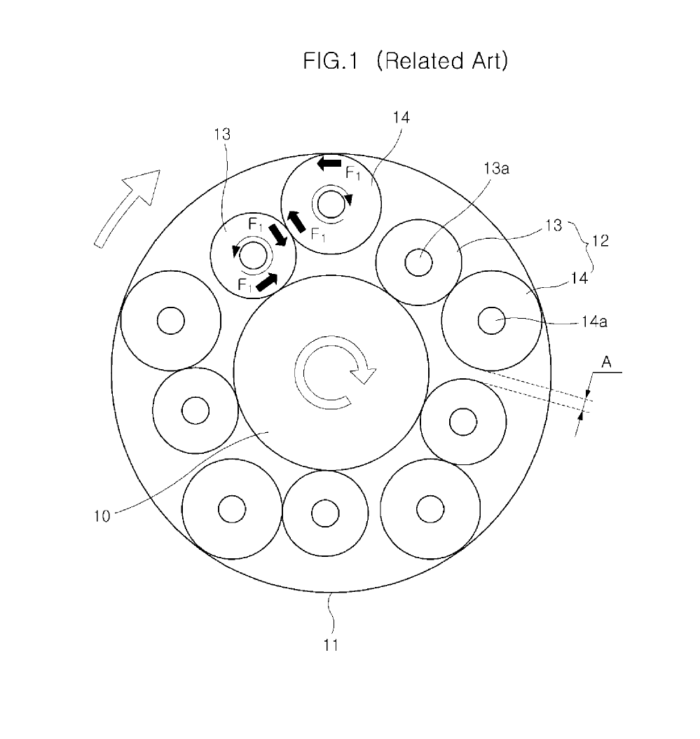

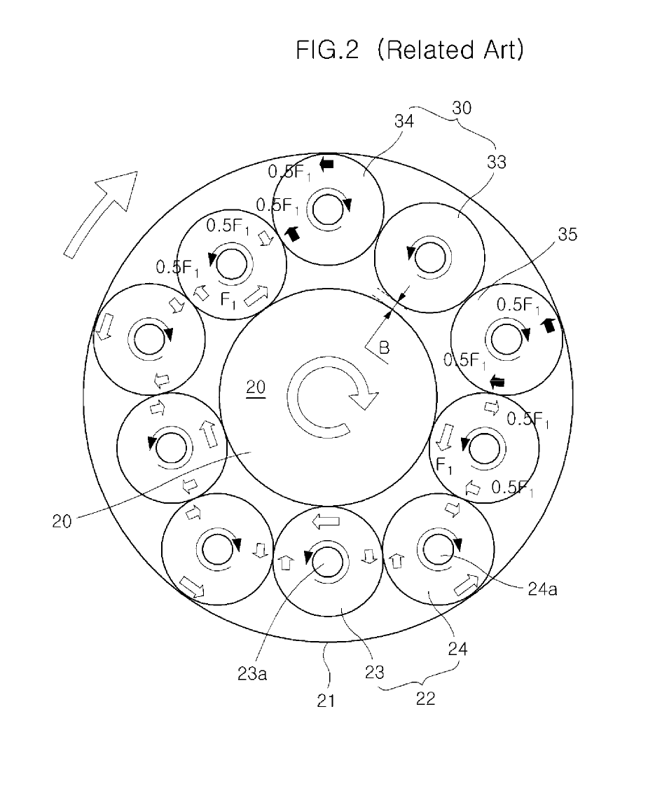

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Exemplary embodiments of the present invention are described hereafter in detail with reference to the accompanying drawings, and the exemplary embodiments can be achieved in various ways by those skilled in the art and the present invention is not limited to the exemplary embodiments.

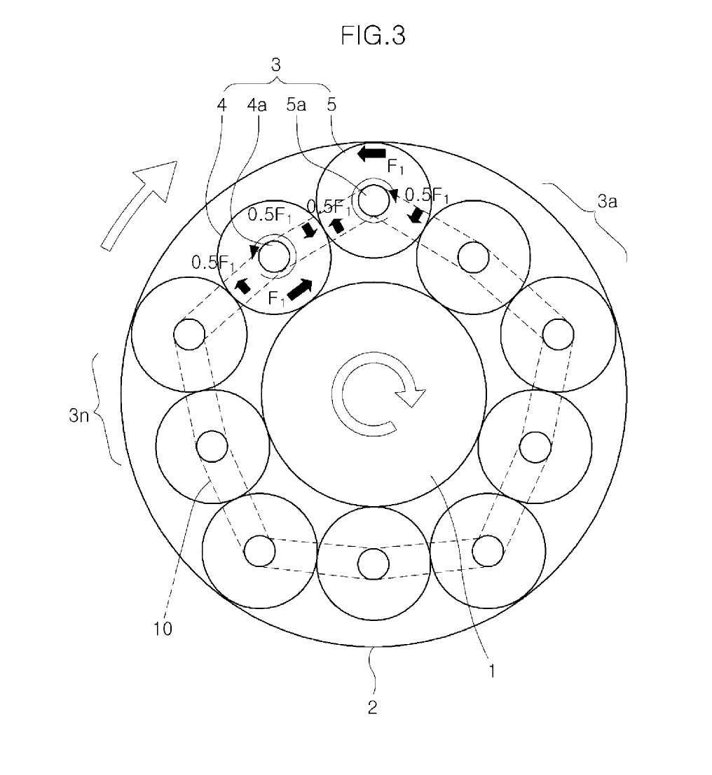

FIG. 3 is a view showing the configuration of a double pinion type of planetary gear device according to an exemplary embodiment of the present invention.

As shown in the figure, a planetary gear device includes a sun gear 1 and a ring gear 2, a plurality of double pinion gears 3 is arranged between sun gear 1 and ring gear 2, double pinion gears 3 are each composed of a first pinion gear 4 having a pinion shaft 4a equipped with a planetary carrier 10 in contact with sun gear 1 and a second pinion gear 5 having a pinion shaft 5a equipped with the planetary carrier 10, in contact with ring gear 2.

Double pinion gears 3 follow the specifications of sun gear 1 and ring gear 2, but five double pinion gears 3, 3a, . . . , 3n are exemplified in the exemplary embodiment and five double pinion gears 3, 3a, . . . , 3n have the same specification.

Double pinion gears 3 according to the exemplary embodiment of the present invention are arranged such that first pinion gears 4 are in contact with sun gear 1 and second pinion gears 5 are in contact with ring gear 2.

Further, first pinion gears 4 and second pinion gears 4 are in contact with each other, such that first pinion gears 4 are in contact with all of second pinion gears 5 at both sides and second pinion gears are in contact with all of first pinion gears 4 at both sides.

According to the structure, first pinion gear 4 is in contact at total three points, that is, one contact point with sun gear 1 and two contact points with second pinion gears 5 while second pinion gear 5 is also in contact at total three points, that is, one contact point with ring gear 2 and two contact points with first pinion gear 4.

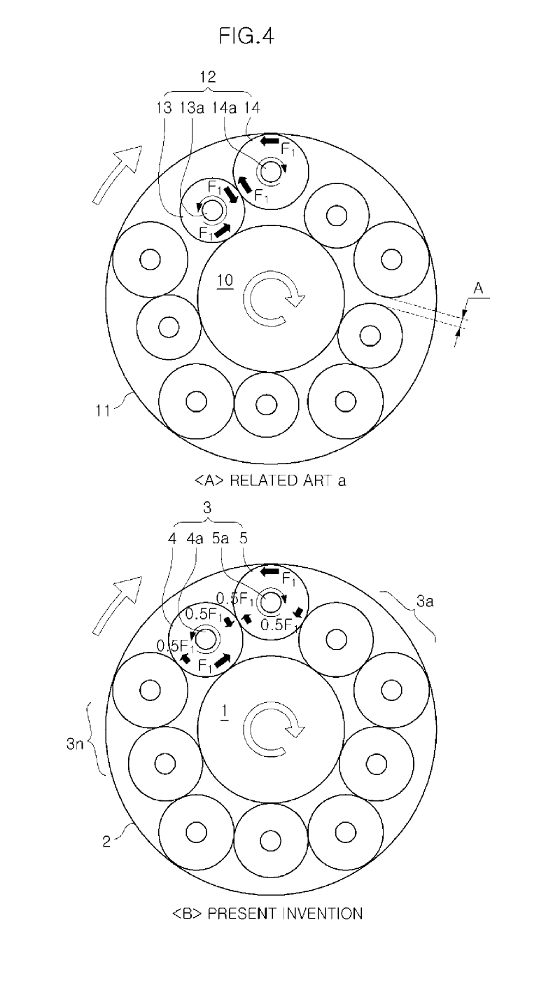

FIG. 4 compares the operation of the double pinion type of planetary gear device according to the exemplary embodiment of the present invention with a structure of the related art.

As shown in the figure, in a double union type of planetary gear device of the related art indicated by (A), first pinion gears 13 and second pinion gears 14 are in contact with a sun gear 10 and a ring gear 11, respectively, and adjacent first pinion gear 13 and second pinion gear 14 are spaced apart at a distance A from each other, such that force F1 is applied to the contact surface between first pinion gear 13 and second pinion gear 14 while radial force exists, such that large resultant force is applied to pinion shafts 13a and 14a. Accordingly, efficiency and durability are low in this structure.

However, in the double pinion type of planetary gear device according to the exemplary embodiment of the present invention, first pinion gears 4 are in contact with sun gear 1 and with both sides of second pinion gears 5, that is, at total three points.

As a result, it is possible to reduce the force applied to first pinion gears 4 and second pinion gears 5 by ½ and offset the radial force, such that the force exerted in pinion shafts 4a and 5a that are rotary shafts of first pinion gears 4 and second pinion gears 5, is largely decreased, and accordingly, it is possible to considerably increase the efficiency and improve the durability of the double pinion type of planetary gear device.

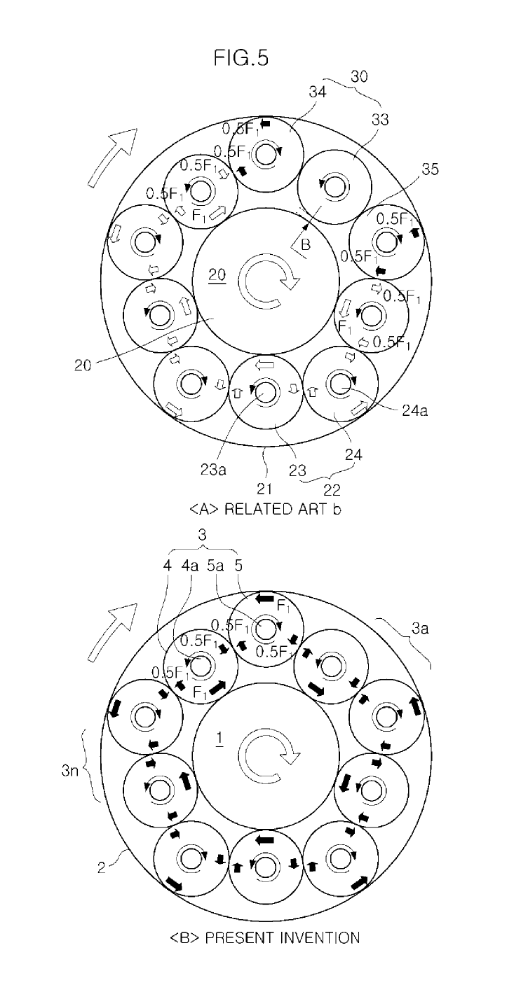

FIG. 5 compares the operation of the double pinion type of planetary gear device according to the exemplary embodiment of the present invention with another structure of the related art.

As shown in the figure, in a double pinion type of planetary gear device of the related art indicated by (A), first pinion gears 23 and second pinion gears 24 are in contact with a sun gear 20 and a ring gear 21, respectively, and they are in contact at both sides, but at least one of first pinion gears 33 is spaced apart at a distance B from sun gear 20.

Further, the number of pinion gears is not increased, and the radial balance of the total force of the planetary gear device is broken by radial force generated by second pinion gears 34 and 35 by the both-directional contact of first pinion gear 33 that is not in contact with sun gear 20 and the motion of the planetary carrier and ring gear 21 is made not symmetrical, but asymmetrical, such that it necessarily causes vibration.

On the contrary, according to the double pinion type of planetary gear device of the exemplary embodiment of the present invention, as described above, it is possible to considerably improve the durability by significantly reducing the force exerted in pinion shafts 4a and 5a that are the rotary shafts of first pinion gear 4 and second pinion gear 5, and the force at the ring gear 2 receiving force through first pinion gears 4 and second pinion gears 5 are balanced, such that it is possible to achieve a double pinion type of planetary gear device that is excellent against vibration.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. A planetary gear device with double pinion gears arranged between a sun gear and a ring gear, wherein each of the double pinion gears has a planetary carrier fitted on a pinion shaft that is a rotary shaft, a plurality of the double pinion gears having a first pinion gear being in contact with the sun gear at one point and a second pinion gear being in contact with the ring gear at one point, which makes a pair, is arranged in a plurality of pairs, and the first pinion gear and the second pinion gear are in contact at three points.

2. A planetary gear device with a plurality of double pinion gears arranged between a sun gear and a ring gear, wherein each of the double pinion gears has:
a first pinion gear having a first pinion shaft wherein the first pinion gear is engaged with the sun gear;
a second pinion gear having a second pinion shaft wherein the second pinion gear is engaged with the ring gear and the first pinion gear; and
a planetary carrier fitted on the first and second pinion shafts,
wherein each double pinion gear is disposed between the sun gear and the ring gear in series and a second pinion gear of a double pinion gear is engaged with a first pinion gear of an adjacent double pinion gear such that a first pinion gear of each double pinion gear is in contact with the sun gear and adjacent second pinion gears at three points and a second pinion gear of each double pinion gear is in contact with adjacent first pinion gears and the ring gear at three points.
